(19) United States
(12) Patent Application Publication
(10) Pub. No.: US 2014/0102040 A1
(43) Pub. Date: Apr. 17, 2014

(54) WALL ANCHOR ASSEMBLY AND METHOD OF INSTALLATION

(71) Applicants: Dale J. Crook, Olathe, KS (US); Lynn R. Bean, Olathe, KS (US)

(72) Inventors: Dale J. Crook, Olathe, KS (US); Lynn R. Bean, Olathe, KS (US)

(21) Appl. No.: 14/054,472

(22) Filed: Oct. 15, 2013

Related U.S. Application Data
(60) Provisional application No. 61/713,680, filed on Oct. 15, 2012.

(51) Int. Cl. F16B 37/00

(52) U.S. Cl. CPC F16B 37/00
USPC 52/745.21; 411/427

(57) ABSTRACT

A wall anchor assembly and method of installing such to a wall assembly, ceiling assembly, door, or other surface. The wall anchor assembly generally includes a thin line anchor which includes a drill guide, a threaded receiver, and a pair of cord holes. A flexible cord is threaded through the cord holes and can be used to position the anchor on the interior face of a wall assembly once a hole is drilled using the drill guide located on the anchor and the anchor has been inserted through the drilled hole. The anchor may be made from cutting a flat bar or stamping, milling, extruding, or molding the anchor from steel, aluminum, or plastic.

### CROSS-REFERENCE TO RELATED APPLICATION

This application claims priority in U.S. Provisional Patent Application No. 61/713,680, filed Oct. 15, 2012, which is incorporated herein by reference.

### BACKGROUND OF THE INVENTION

1. Field of the Invention

The present invention relates generally to a wall anchor and more specifically to a thin line anchor capable of being inserted through a thin hole or slot in a wall or between tiles to act as an anchor for a mounted element.

2. Description of the Related Art

Wall anchors are used to mount different elements to walls or wall structures. These can be anything from hooks for hanging curtains or frames, to platforms mounted to sections of a tiled wall. Existing anchors require cutting or drilling tile or wall board to attach an item to the wall. The prior art requires a large hole, such as to fit through a butterfly anchor, so that the mounting anchor can be inserted. This can cause chipping of walls or tile, and can often be too large for the object being mounted.

The typical butterfly toggle is the standard prior art. The toggle employs a springed hinge such that the toggle can be pinched to a horizontal body which springs open into wings once the body has been pushed through a predrilled hole in the wall. As said above, this can cause unwanted damage to the wall or tile that was predrilled. What is needed is an anchor capable of being inserted through a thin drilled line in a hole or a wall, such that it could fit between tiles in a grout line eliminating the chance of breaking or chipping tiles during installation.

The invention presented herein solves these issues by utilizing a small slot which allows the anchor to be removed and a patch to be simply placed over that slot, and the present invention features no moving parts and additional surface area for a stronger anchor position. Heretofore, there has not been available a wall anchor with the advantages and features of the present invention.

### SUMMARY OF THE INVENTION

In the practice of the present invention, a preferred embodiment thin line anchor includes a body with a drilling guide approximately the width of the anchor body, and a height relative to the thickness of the anchor body. Two string holes are located on opposite sides of a third, threaded hole centrally located along the body of the anchor. At least one end of the anchor includes a point increasing the ability of the anchor to be driven through a predrilled hole in a wall or the grout between tiles.

A flexible cord or string is threaded through the pair of string holes. A hole is drilled in a wall portion using the drill guide, then a pointed end of the anchor is inserted into the hole, the anchor is pushed or hammered through the hole, and the string is used to pull the anchor against the back of the wall portion while the mounting element is mounted to the anchor via a threaded rod being threaded through the threaded hole of the anchor. The anchor may be made by stamping, milling, extruding, or molding the anchor from steel, aluminum, or plastic.

Another embodiment may be made out of a simple bar of metal which includes at least a centralized threaded hole, a pair of string holes, a point, and a drill hole guide.

Alternatively, the anchor may be driven straight through a wall or other structure without pre-drilling a slot or hole. The pointed end of the anchor can be used to pierce many materials.

Embodiments of the present invention may also be used to anchor hanging elements from doors, ceilings, and floors.

### BRIEF DESCRIPTION OF THE DRAWINGS

The accompanying drawings illustrate the principles of the present invention and an exemplary embodiment thereof.

FIG. 1 is an isometric perspective view of an embodiment of the present invention.

FIG. 2 is an isometric perspective view thereof, showing the reverse face of the present invention.

FIG. 3 is a top plan view thereof.

FIG. 4 is a right side elevational view thereof, the left side being a mirror image.

FIG. 5 is a front side elevational view thereof.

FIG. 6 is a sectional view thereof, showing the present invention in a typical environment in a first installation step.

FIG. 7 is a sectional view thereof, showing the present invention in a typical environment in a second installation step.

FIG. 8 is a sectional view thereof, showing the present invention in a typical environment in a third installation step.

FIG. 9 is an elevational view of a wall section with tiles showing the installation of a preferred embodiment of the present invention.

FIG. 10 is an elevational view thereof, showing an anchor being inserted into a pre drilled slot.

FIG. 11 is a top plan view of an alternative embodiment of the present invention.

### DETAILED DESCRIPTION OF THE PREFERRED EMBODIMENT

### I. Introduction, Environment, and Preferred Embodiment

As required, detailed aspects of the present invention are disclosed herein, however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

A typical embodiment of the present invention would be used in a typical building environment. The thin line anchor presented herein could be used to mount elements to plain walls, tiled walls, or vertically oriented surfaces, as well as hollow structures such as doors, ceilings, floors, concrete blocks, or other construction elements. The anchor is used to predrill an insertion hole, and is inserted into the hole such that a threaded rod can be mounted to the anchor.

### II. Preferred Embodiment Thin Line Anchor 2

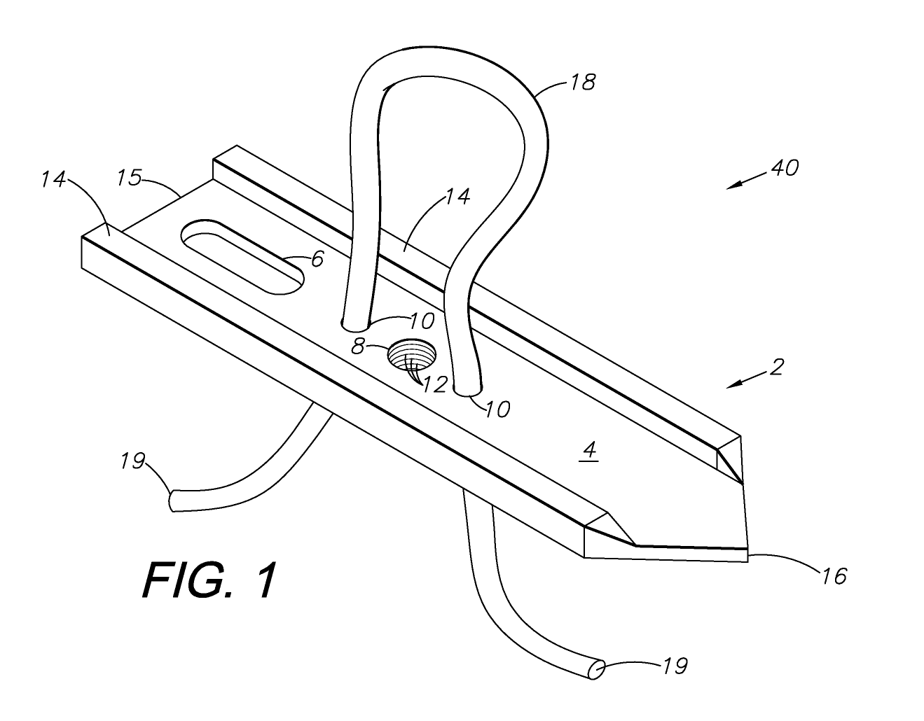

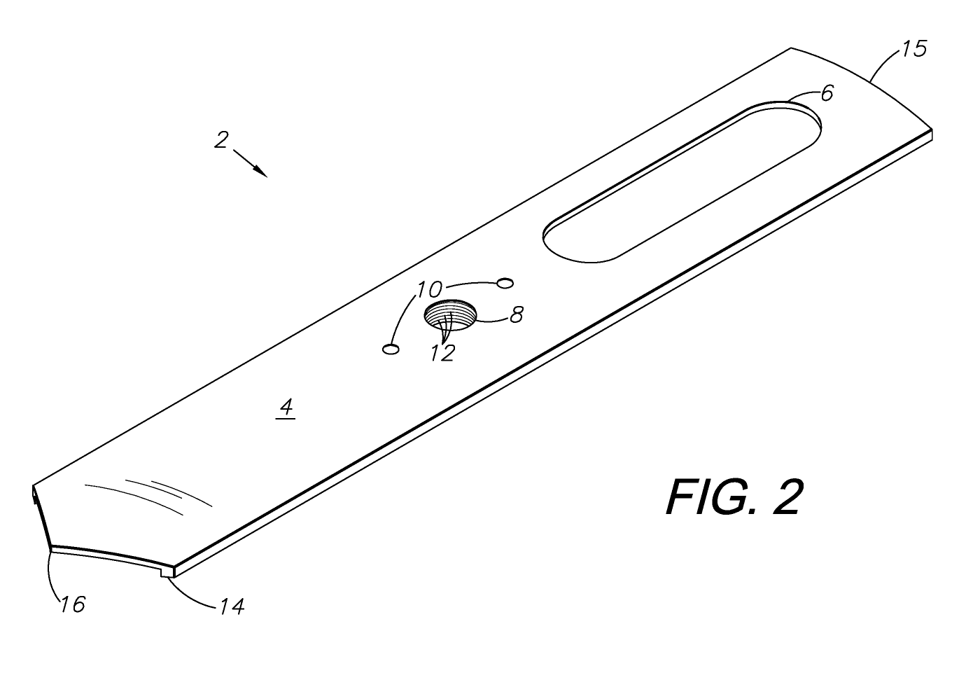

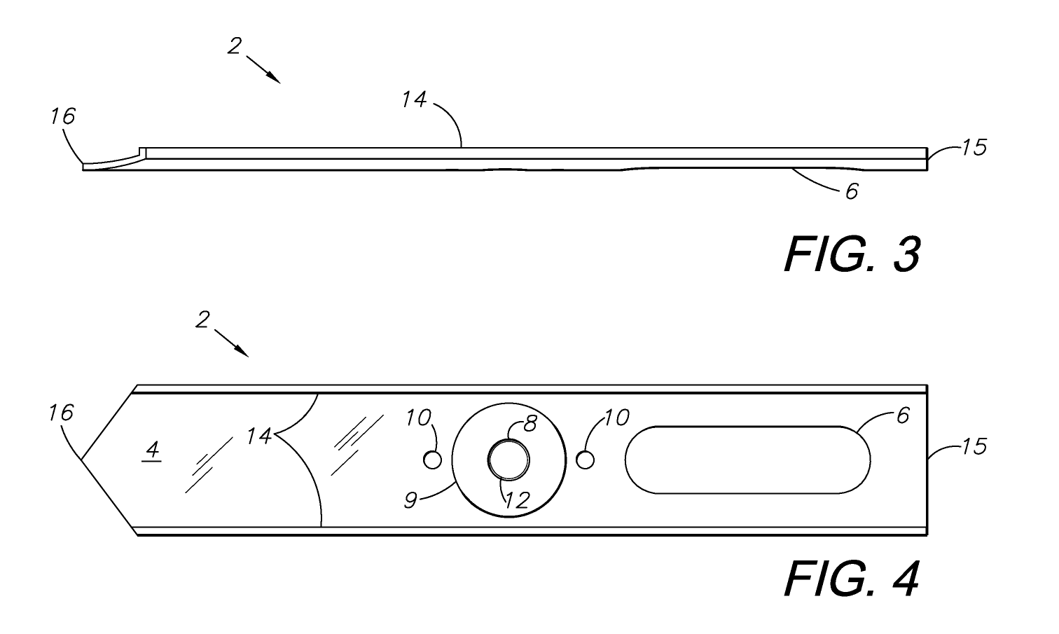

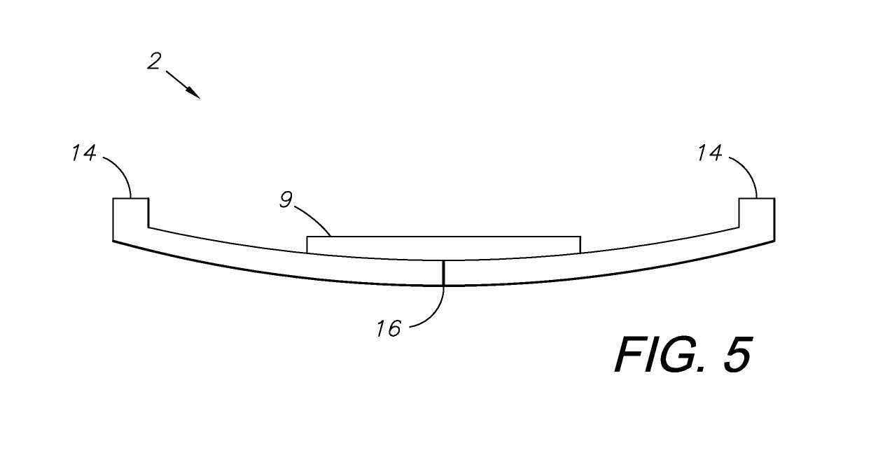

FIGS. 1 and 2 generally shows a preferred embodiment thin line anchor 2 with a flexible cord string 18 threaded through two string holes 10 located on the generally planar body 4 of the anchor. The cord string 18 is generally thin, typically between 1 mm and 3 mm in diameter. A threaded thru hole 8 including a plurality of threads 12 and operating as a female opening for receiving a threaded rod or bolt 32 is located centrally on the body 4 of the anchor between the two string holes 10. The threaded thru hole 8 may include a raised boss 9. The anchor may include raised edges 14 for additional strength. FIGS. 3-5 provide additional clarification of these features.

The anchor 2 is placed against a wall surface or aligned over the grout between two tiles. The drill guide 6 is used to drill a thin drilled hole 26 into the wall or between tiles. Any handheld drill can be used to perform this task. Alternatively, the anchor 2 could be driven into a structure without pre-drilling by striking the back edge 15 and piecing the structure with the pointed end 16.

The flexible cord string 18 is looped through the string holes 10, and the point 16 of the anchor 2 is inserted into the drilled hole 26. The ends 19 of the cord string 18 are held on one side of the wall surface while the anchor is pushed or hammered through the drilled hole by placing pressure on the back edge 15.

The cord string 18 prevents the anchor 2 from slipping behind the wall surface. A tug on the cord presses the flat rear face of the anchor body 4 against the rear face of the wall structure. A threaded rod 32 can then be slipped through the predrilled hole and threaded into the threaded thru hole 8 receiver. The mounted element 30 can be tightened down, thereby pressing a rear face of the mounted element against the front face of the wall structure, and the rear face of the anchor body 4 against the rear face of the wall structure. This keeps the entire mounting assembly 40 in place. The cord string 18 may then be removed by tugging one end 19 of the string through the assembly until it slides out of the drilled hole 26.

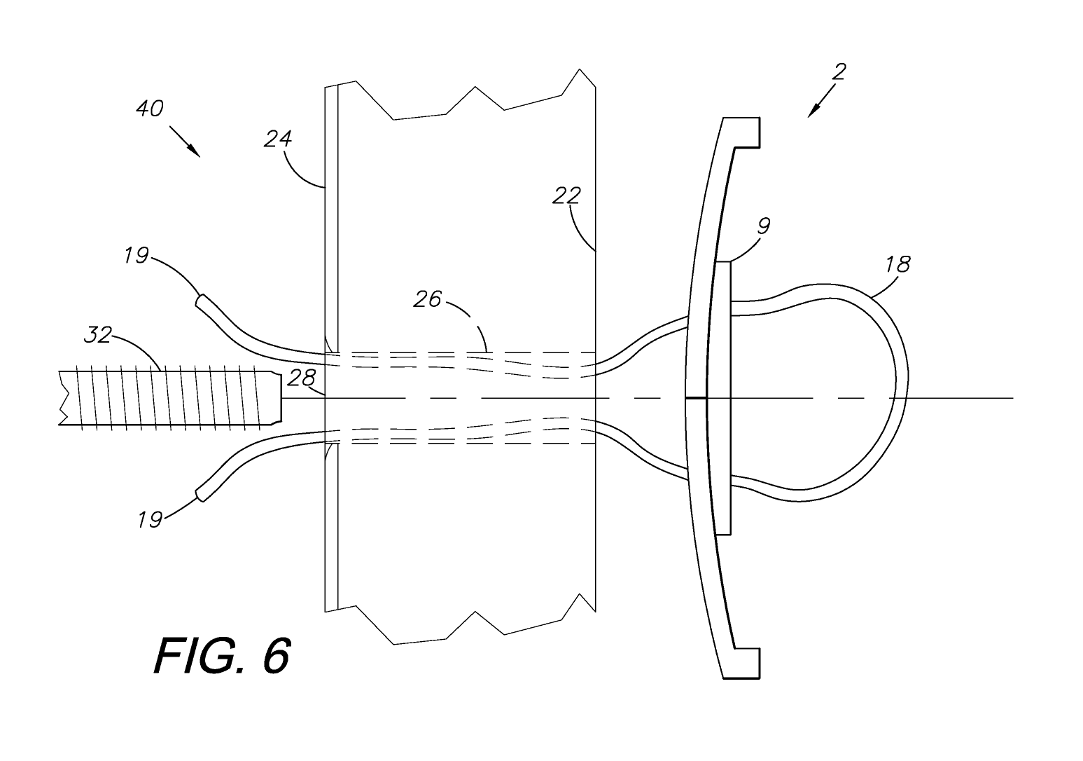

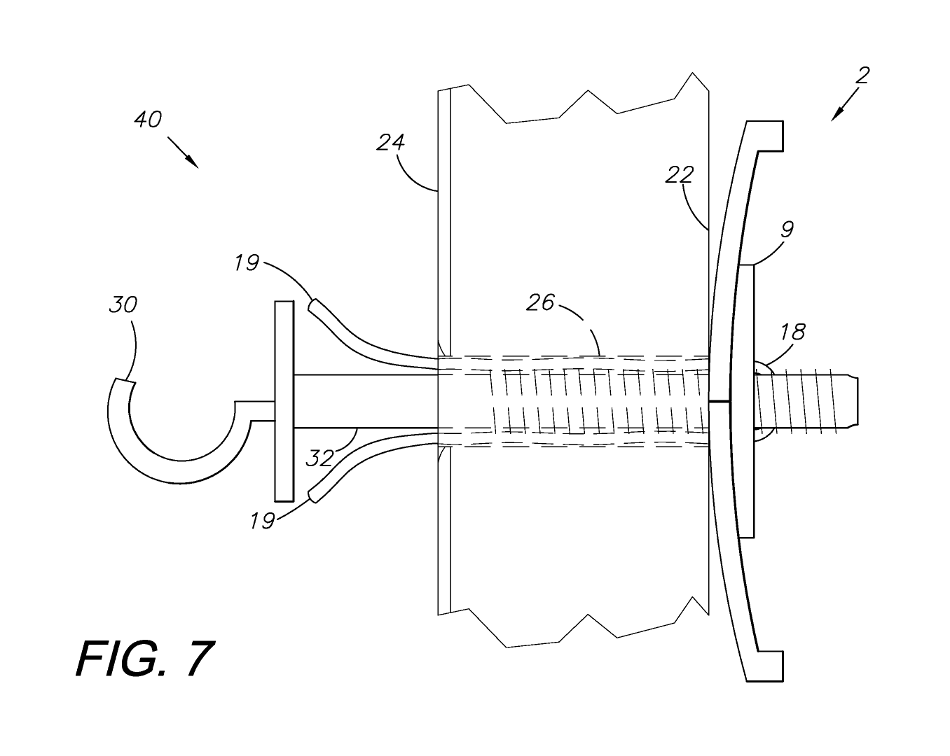

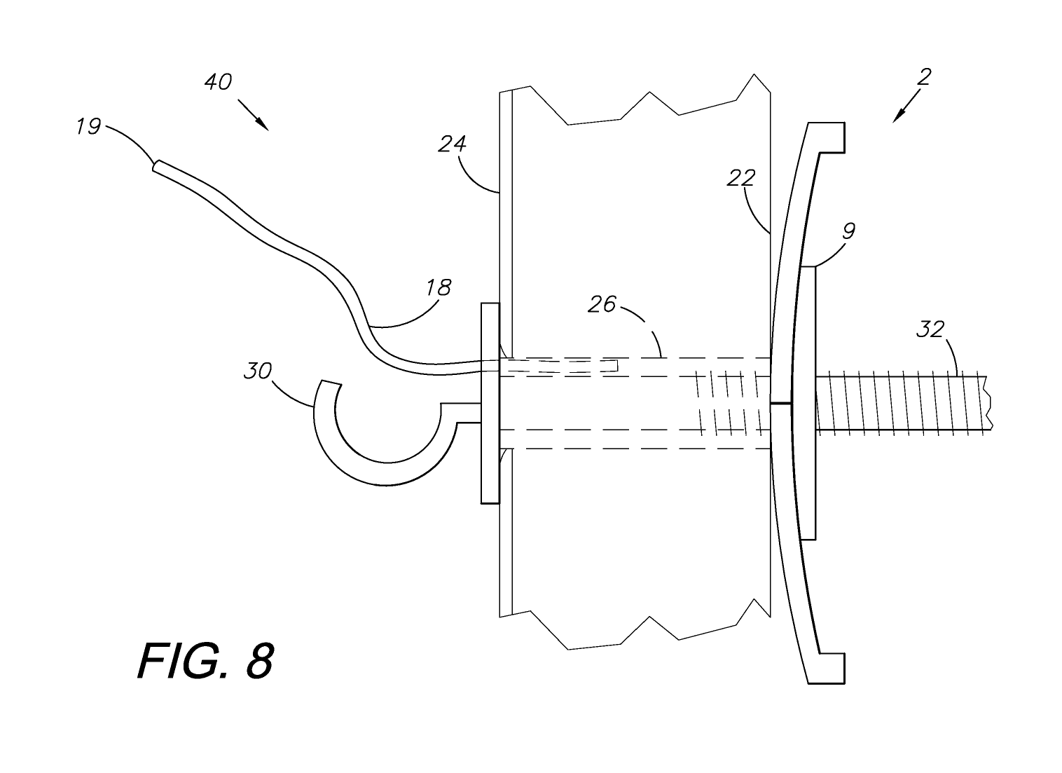

FIGS. 6-8 demonstrate some of the steps of installing the mounting assembly 40 to a wall 22 after the pre-drilled wall hole 26 has been drilled. As discussed above, the present invention functions by “sandwiching” a wall structure 22 to create an anchor point. The anchor 2 is held up to the wall and the drill guide 6 allows the hole 26 to be drilled at the location. On a wall containing tiles 24, the hole would ideally be drilled at the grout line 28 as shown in FIG. 6. The flexible cord 18 is inserted through the string cord holes 10, and then the anchor 2 is driven through the predrilled hole 26. As shown in FIGS. 7-8, the threaded bolt 32 is inserted through wall hole 26 and threaded into the anchor 2. Then the flexible cord 18 is pulled out and discarded.

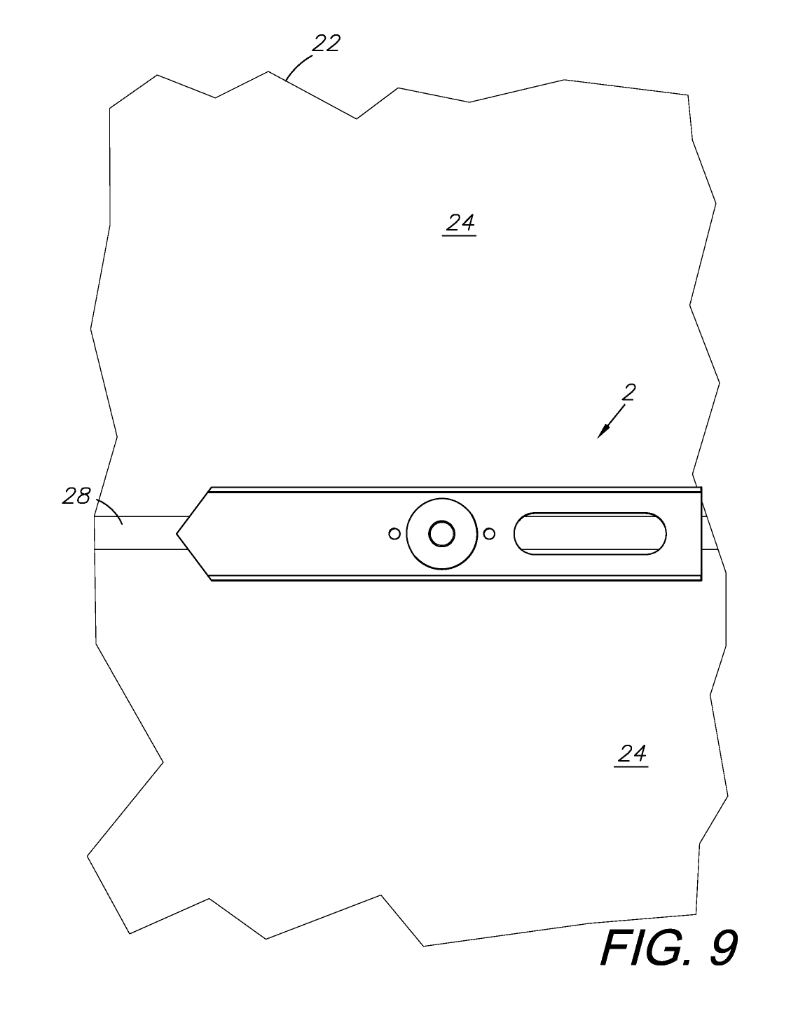

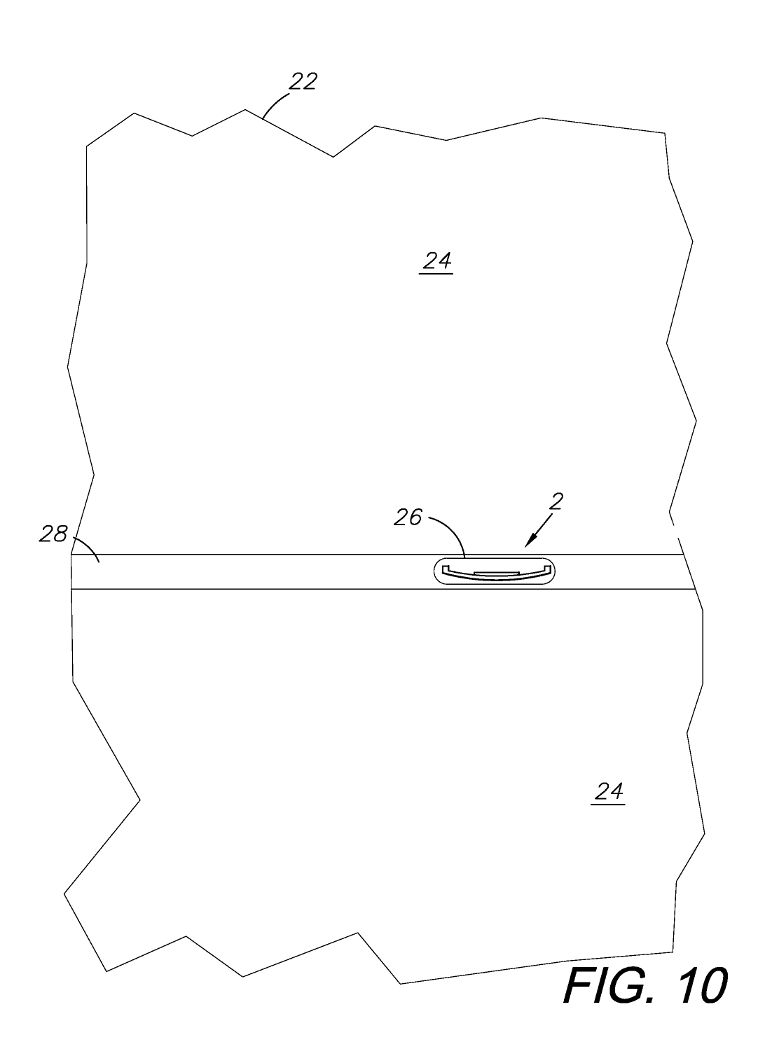

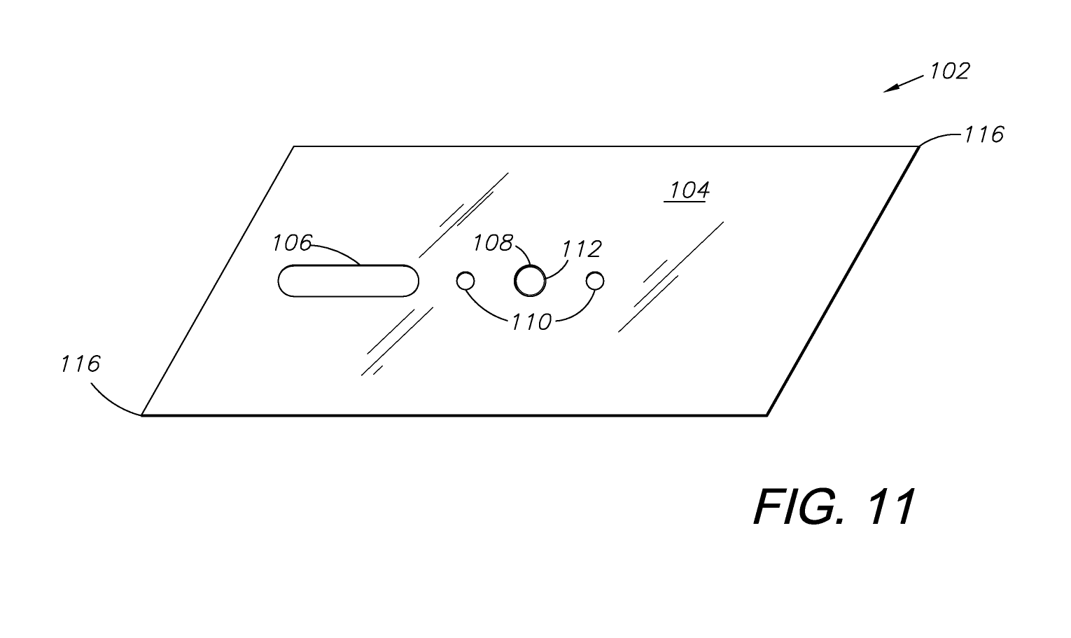

FIGS. 9-10 show previous steps, wherein FIG. 9 shows the drill guide 6 being lined up over a grout line 28. A hole 26 is drilled, as shown in FIG. 10, and the anchor 2 is inserted through the hole.

It should be noted that in some cases anchor 2 may be driven straight through a wall section without the need to pre-drill a hole. The pointed end 16 of the anchor 2 can effectively puncture some wall structures.

### III. Alternative Embodiment 102

An alternative anchor 102 may be formed out of a flat bar. A flat bar may be cut such that each anchor includes two points 116. The alternative anchor also includes a generally planar anchor body 104, a drill guide slot 106, a threaded mounting hole 108 with threads 112, and a pair of cord string holes 110.

It is to be understood that while certain aspects of the disclosed subject matter have been shown and described, the disclosed subject matter is not limited thereto and may include various other embodiments and aspects.

Having thus described the invention, what is claimed as new and desired to be secured by Letters Patent is:

1. An anchor assembly comprising:
a anchor having a generally planar anchor body;
a drill hole guide passing through said anchor body, the width of said drill hole greater than the width of said anchor body, and the height of said drill hole guide greater than the thickness of said anchor body;
a threaded receiver passing through said anchor body;
a pair of cord receiver holes passing through said anchor body; and
a flexible cord adapted for threading through said cord receiver holes.

2. The anchor assembly of claim 1, further comprising:
said anchor body having a proximal end and a distal end;
said anchor body distal end being generally pointed; and
said anchor body proximal end being generally blunted.

3. The anchor assembly of claim 2, further comprising:
said anchor body distal end adapted for being driven through a predrilled hole in a wall structure.

4. The anchor assembly of claim 2, further comprising:
said anchor body proximal end adapted for being struck, thereby driving said anchor through a predrilled hole in a structure.

5. The anchor assembly of claim 4, further comprising:
said structure comprising an interior face and an exterior face; and
said flexible cord adapted for temporarily positioning said anchor against said interior face of said structure.

6. The anchor assembly of claim 5, further comprising:
said structure exterior face comprising a plurality of tiles;
each of said plurality of tiles joined together via a plurality of grout lines; and
wherein said predrilled hole is located at one of said plurality of grout lines.

7. The anchor assembly of claim 1, wherein said anchor body is comprised of a cut flat bar.

8. The anchor assembly of claim 1, further comprising:
a mounting element including a threaded bolt; and
wherein said threaded bolt is threaded through said threaded receiver of said anchor.

9. The anchor assembly of claim 6, wherein said mounting element comprises a hook.

10. A method of installing an anchor assembly into a building structure, the method comprising the steps:
placing a wall anchor against a structure, said wall anchor comprising a generally planar anchor body, a drill hole guide passing through said anchor body, a threaded receiver passing through said anchor body, and a pair of cord receiver holes passing through said anchor body;
drilling an anchor hole through said building structure at a location indicated by said drill hole guide;
threading a flexible cord through said pair of cord receiver holes, said flexible cord having a first end and a second end;
inserting said anchor through said anchor hole, such that said first and second ends of said flexible cord are positioned in proximity to an exterior face of said building structure, and said anchor is positioned in proximity to an interior face of said building structure;
said flexible cord holding said anchor against said interior face of said building structure;
inserting a threaded bolt through said anchor hole;
threading said threaded bolt through said threaded receiver of said anchor such that said anchor is pressed against said interior face of said wall structure; and
withdrawing said flexible cord from said anchor hole.

11. The method according to claim 10, wherein a mounting element is affixed to said threaded bolt.

12. The method according to claim 11, wherein said mounting element comprises a hook.

13. The method according to claim 10, wherein said anchor body is comprised of a cut flat bar.

14. The method according to claim 10, wherein:
said anchor body having a proximal end and a distal end;
said anchor body distal end being generally pointed; and
said anchor body proximal end being generally blunted.

15. The method according to claim 14, wherein said anchor body distal end is adapted for being driven through said anchor hole in said building structure.

16. The method according to claim 14, wherein said anchor body proximal end is adapted for being struck, thereby driving said anchor through said anchor hole in said building structure.

17. The method according to claim 10, wherein said exterior face of said wall structure is comprised of a plurality of tiles, and wherein grout is located between each of said plurality of tiles.

18. The method according to claim 17, wherein said anchor hole is located at a grout line located between two of said plurality of tiles.
